(19) United States
(12) Patent Application Publication
(10) Pub. No.: US 2004/0021324 A1
(43) Pub. Date: Feb. 5, 2004

(54) Mechanism for manoeuvring a door

(76) Inventors: Bertrand Fonterneau, Moulins (FR); Thierry Acheron, Moulins (FR); Quentin Baillia-Prel, Moulins (FR); Pascal Berger, Marigny (FR); Thierry Bernard, Avermes (FR); Jean-Paul Bijon, Neuilly Le Real (FR); Coltel Gilles, Besson (FR); Lecointe Xavier, Moulins (FR); Eric Sallet, Chemin des Chaux (FR)

Correspondence Address: YOUNG & THOMPSON, 745 SOUTH 23RD STREET 2ND FLOOR, ARLINGTON, VA, 22202

(21) Appl. No.: 10/381,144

(22) PCT Filed: Sep. 20, 2001
(86) PCT No.: PCT/FR01/02927

(30) Foreign Application Priority Data
Sep. 21, 2000 (FR) 00 12033

(51) Int. Cl. E05C 19/10

(52) U.S. Cl. 292/98

(57) ABSTRACT

A mechanism for manoeuvring a door more particularly designed to be associated with a bar for avoiding panic. The mechanism comprises a pivoting bolt (26) provided with a slot wherewith it can co-operate with a lock-bolt keeper, a pivoting cam (35) for preventing the bolt from rotating towards a so-called loose escaping position and a member actuating (45) the cam to release the bolt.

The invention relates to a door maneuvering mechanism, more particularly one adapted to be integrated into an emergency exit door opening device including a panic bar.

An emergency exit door equipped with a panic bar must above all else open easily when the bar is actuated, even if a high force (up to 100 kg according to the standards) is applied to the door itself and tends to oppose correct operation of the mechanism.

In a conventional system, panic-stricken persons pushing on the door tend to oppose the normal retraction of the bolt. Because of this the door is more difficult to open, since maneuvering the panic bar requires a greater force.

Also, conventional systems are known to be easy to force open from the outside. To overcome this problem, some systems additionally include bolts, violating statutory provisions, since emergency exits should never be locked from the inside.

One object of the invention is to propose a door maneuvering mechanism, in particular of the panic bar type, controlled by a pushbar and in which the force to be applied to maneuver the bolt to open the door is relatively insensitive to any force that may be applied to the door itself.

To this end, the invention provides a door maneuvering mechanism, in particular of the panic bolt type, characterized in that it includes, installed on a support adapted to be fixed to a door:

a pivoting bolt with a slot adapted to receive a keeper external to said support,

a pivoting cam with an abutment cooperating with a profiled nose of said bolt to prevent rotation thereof in a direction that would allow said bolt to reach an escape position in which said bolt and said keeper can separate, and

an actuator member for actuating said cam, cooperating with an arm thereof to retract said abutment, and adapted to release said pivoting bolt to allow it to reach said escape position.

Another object of the invention is to propose a more secure mechanism for protecting goods, i.e. offering good resistance to attempts to break in from the outside.

To this end, the invention also provides a mechanism as defined above, characterized in that one edge of said slot in said bolt is part of a weakened portion thereof, adapted to be bent by an external force to a position where the force developed between the keeper and the bolt is substantially directed in the direction of the rotation axis of the latter.

Consequently, if the door is forced from the outside, the pivoting bolt is deformed, which modifies the direction of the force developed between the keeper and the bolt, with the result that the torque generated on the latter is cancelled out. From this moment, the bolt is no longer the weak point of the mechanism.

Another object of the invention is to modify the above device so that the door can be opened from the outside.

To this end, the mechanism according to the invention is characterized in that it includes actuator means for actuating said cam connected to a cylinder and/or a nut, cooperating with said cam to release said bolt and allow it to reach said escape position.

To be more precise, said actuator means include a tab cooperating with said cam and fastened to a mobile plate adapted to be moved to a position of mechanical coupling with said cylinder and/or said nut. For example, the plate is moved by a dog commanding its coupling with a nut and said dog is moved by a cylinder.

The invention will be better understood and other advantages of the invention will become more apparent in the light of the following description, which is given by way of example only and with reference to the accompanying drawings, in which:

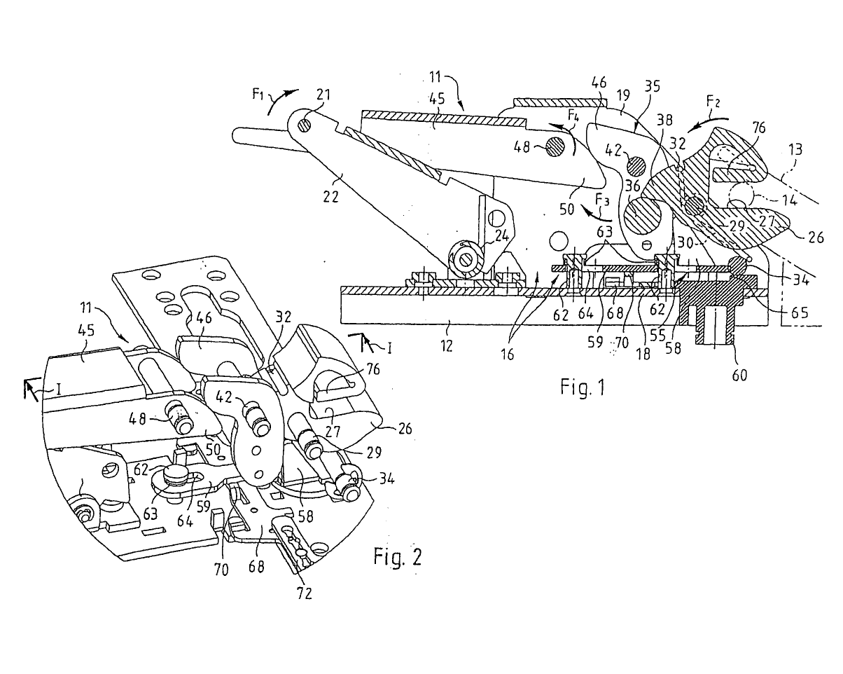

FIG. 1 is a general view of the mechanism in section taken along the line I-I in FIG. 2, showing the configuration of the mechanism when the door is closed;

FIG. 2 is a partial perspective view of the same mechanism in the same configuration;

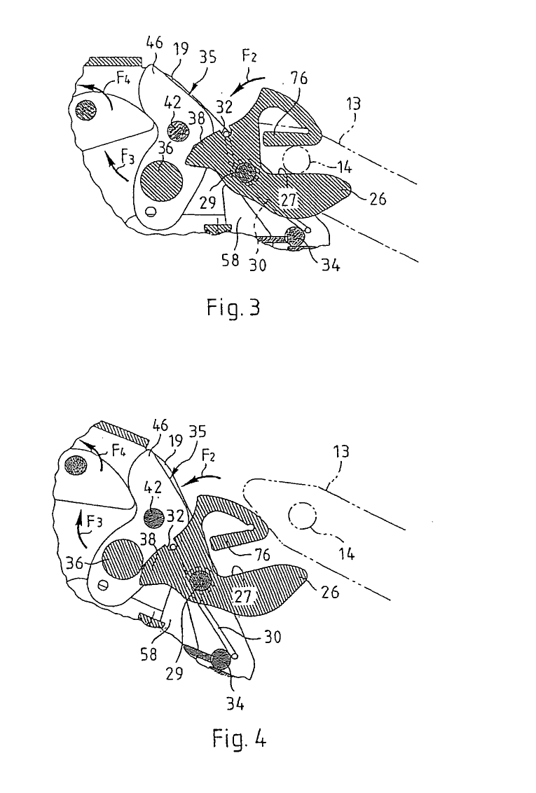

FIG. 3 is a partial view in section of the same mechanism at the beginning of a phase of opening the door by actuating the panic bar;

FIG. 4 is a partial view in section of the same mechanism during opening of the door by actuating the panic bar;

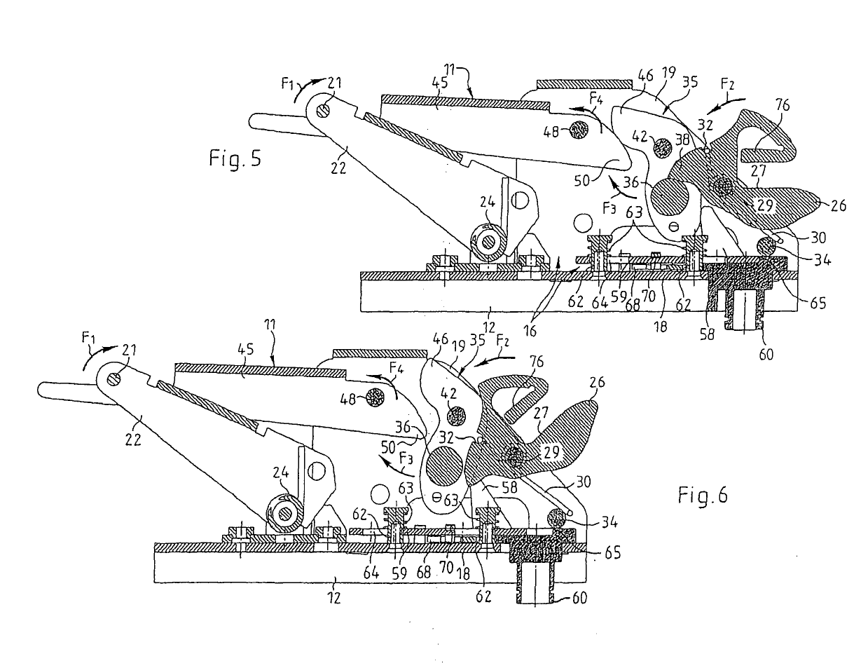

FIG. 5 is a partial view in section of the mechanism at the beginning of a phase of opening the door by actuating the nut;

FIG. 6 is a partial view in section of the mechanism during opening of the door by actuating the nut; and

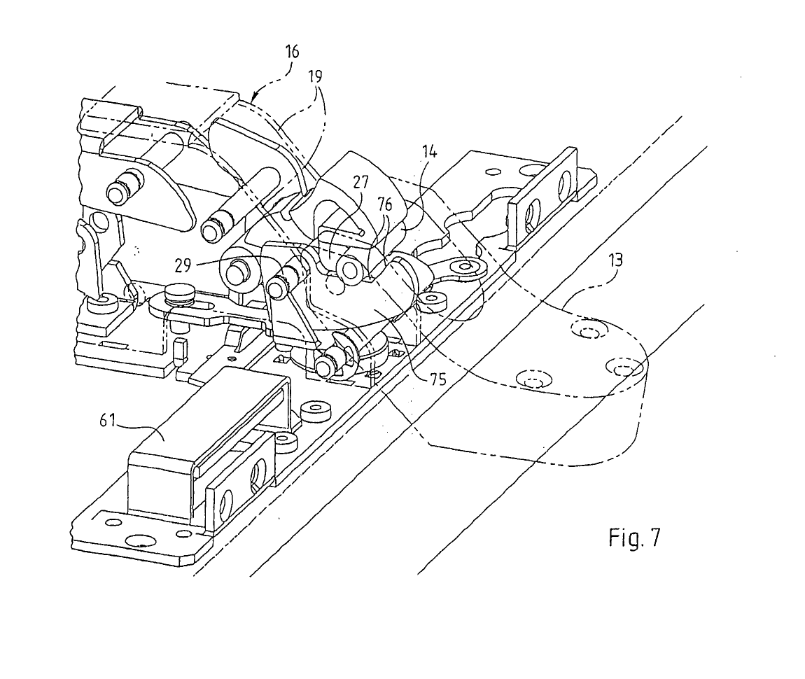

FIG. 7 is a perspective view of a variant designed for double doors.

Referring more particularly to FIGS. 1 to 5, there is shown a maneuvering mechanism 11 adapted to be mounted on the surface of a door 12 equipped with a panic bar (not shown). The mechanism cooperates with a keeper fixed to the door frame. The keeper 13 is shown in dashed outline in FIG. 1. It has two parallel arms between which extends a cylindrical crossmember 14. The same keeper is also shown in perspective and in dashed outline in FIG. 7.

A support 16 adapted to be fixed to the door at the level of the panic bar carries the various component parts of the mechanism. The support includes a base 18 fixed to the door and two parallel flanges 19 perpendicular to and attached to the base. The base 18 is a globally T-shaped metal plate. The pivots of the components described hereinafter consist of journals extending between the two flanges. The flanges are in fact the two parallel portions of a U-shaped sheet metal component fixed to the base.

In FIGS. 2 to 6, the flanges that carry the journals are omitted so as not to conceal the essential components of the mechanism. The flanges are shown in dashed outline in FIG. 7.

One end of the panic bar is articulated to one end 21 of a lever 22 which pivots on the base 18. A spring 24 on the base spring loads the lever in the rotation direction shown by the arrow F1 in FIG. 1. The lever is cut out from a U-section.

The support 16 carries a pivoting bolt 26 adapted to receive the keeper, fastened to the door frame, more particularly the cylindrical crossmember 14 thereof. To this end, the bolt incorporates a slot 27 in which said crossmember is engaged when the door is closed. Said pivoting bolt turns about a journal 29 extending between the two flanges 19. A spring 30 wound around the journal has two arms consisting of rectilinear extensions of the turns. One of the arms is curved and engaged in a groove 32 on the bolt and the other arm bears against a shaft 34 between the two flanges 19 and forming an abutment. The spring 30 spring-loads the pivoting bolt in the rotation direction shown by the arrow F2 in FIG. 1.

A pivoting cam 35 carries an abutment 36 taking the form of a roller cooperating with a profiled nose 38 of the bolt 26. When the abutment and the profiled nose are in contact, as shown in FIG. 1, said pivoting cam prevents the bolt rotating in a direction such that it could reach an escape position, shown in FIG. 4, in which said bolt and the keeper can separate. The cam 35 includes two parallel and similar members 46 mounted on a common journal 42 and spaced by the length of the roller. The journal 42 is mounted between the two flanges 19 of the support.

A member 45 for actuating the cam cooperates with one arm 46 of the cam and causes the abutment to retract, i.e. to pivot in the direction of the arrow F3, to release the pivoting bolt, to enable it to reach said escape position.

In this example there are two arms 46 because the cam has two parallel and similar members. There are also two cam actuator members since this component is cut out from a U-section. The actuator member 45 pivots on a journal 48 extending between the two flanges 19. The actuator member has a rounded end portion 50 cooperating with the cam 35, to be more precise the arm 46.

The actuator member 45 has two similar end portions 50 which are rounded, parallel and the same distance apart as said similar members 46 of the cam, with which they respectively cooperate.

The end portions 50 are cut out from the two parallel portions of the section. The cut edges of these two portions cooperate with the respective edges of the two similar members 46 of the cam. Note that the actuator member 45 is extended toward the lever 22, with the result that its travel interferes with that of said lever.

To be more precise, when the lever 22 is actuated, because the bar is pushed, it causes the actuator member to rotate about the journal in the direction of the arrow F4 in FIG. 1.

The mechanism further includes means for actuating the cam 55 connected to a cylinder and/or a nut cooperating with said cam 35 to release the bolt and allow it to reach the escape position. The cylinder and/or the nut is/are accessible from outside the door. The actuator means include a tab 58 cooperating with the cam and fastened to a mobile plate 59. The plate can be moved into a position in which it is mechanically coupled to the cylinder and/or the nut.

In this example, the plate carries two parallel tabs 58 bearing against respective edges of the two similar members 46 of the cam 35.

To be more precise, in this example, the plate 59 moves perpendicularly to the base, so that it can be moved into a position in which it is mechanically coupled to a nut 60, and the plate is moved by a cylinder that is not shown in the drawings.

This is typically a standard “Euro” cylinder carried by the support. The cylinder is housed in a lock case 61 of the support, which can be seen in FIG. 7. The plate 59 moves along two guide rods 62 and is spring-loaded by two springs 63 toward a position in which it cooperates with the nut 60 (see FIG. 5).

To be more precise, the plate 59 includes two oblong holes 64 by means of which it slides along the guide rods 62, and each of the rods is fixed to the base and terminates in at a shoulder forming an abutment, each spring being mounted between this shoulder and the plate 59 itself.

The nut 60, which rotates on the base, has a circular interior surface with a flat 65. One end of the plate can engage in the open portion of the nut and consequently is moved by the edge of the flat 65 if the nut is maneuvered from the outside. Note that the shaft 34, which provides an abutment for the spring 30, is also in contact with the interior face of the nut, which it retains in position on the base. The journal prevents the nut from being pushed in, which could result in it being coupled to the plate, even with the latter in the position shown in FIG. 1. When the nut moves the plate toward the left (as seen in FIG. 6), the tabs 58 cause the cam 35 to pivot, which separates the pivoting bolt 26 and the abutment roller 36, and consequently causes the bolt to pivot toward said escape position.

Movement of the plate 59 in a direction perpendicular to the base 18, for coupling it to or decoupling it from the nut, is commanded by a dog 68 which is commanded by the aforementioned cylinder. This dog consists of a flat member globally perpendicular to the plate 59 (FIG. 2). The dog is placed between the plate 59 and the base 18. The flat member that constitutes it features a boss 70 with inclined edges which, when it is in contact with the plate (FIG. 2), holds it in a position in which it is disengaged from said nut, as shown in FIG. 1. The dog is fixed to a tongue 72 coupled to the basket of the cylinder by a conventional groove arrangement.

Consequently, the position of the dog 68 can be modified by actuating the cylinder. In the position shown in FIGS. 1 and 2, the dog holds the plate at a distance from the nut, which turns “dry”. On the other hand, when actuation of the cylinder causes movement of the dog, the latter slides in its own plane, so that the boss 70 moves away from the plate. The plate 59 is then pushed toward the nut by the springs 63 (FIG. 5), establishing the coupling between the nut and the tabs 58. From this moment, actuating the nut causes movement of the plate, and therefore of the tabs, and leads to pivoting of the cam in the direction of the arrow F3.

Note that one edge of the slot 27 in the bolt is part of a portion 76 thereof weakened by cutting, and liable to bend in response to an external force, to a position in which the force developed between the keeper and the bolt is substantially in the direction of the rotation axis of the latter, i.e. the axis of the journal 29. This bending of the weakened portion of the bolt makes the door more difficult to force, in that, after this deformation of the bolt, a force applied thereto no longer generates any torque on said bolt. FIG. 1 shows in chain-dotted outline the portion 76 after it has been bent.

FIG. 7 shows a variant that is more particularly suitable for installing the mechanism 11 on one of the two doors of a double door. The mounting procedure is as follows. The door that carries the mechanism 11 is fitted with a panic bar and said mechanism, which is installed substantially half way up the door, cooperates with a fixed keeper 13 on the other door.

The second door is also fitted with a panic bar, which operates top and bottom catches for immobilizing the other door in the door frame. There are various door opening situations.

If the door that carries the mechanism is the only one opened, the behavior of said mechanism is similar to that described with reference to FIGS. 1 to 6.

On the other hand, if other door is opened, then the top and bottom closure mechanisms are released and consequently the pivoting bolt of the mechanism 11 mounted on the first door must also be released, to assume the position shown in FIG. 6. The pivoting bolt must be able to assume this position even if the pushbar of the first door is not actuated, not only to avoid impeding the opening of the second door, but also to allow both doors to be closed subsequently.

In this case, to cooperate with the bolt 13 mounted on the second door, said mechanism includes a tripping member 75 pivoting relative to said support and cooperating with the cam 35 to actuate it in a direction that releases the bolt (arrow F3). The tripping member has a cam edge 76 laterally juxtaposed to the slot 27 of the bolt and shaped to cooperate with the keeper so that, when said second door is opened, the bolt actuates said tripping member when it is released, and the tripping member in turn moves the cam 35 to release the pivoting bolt 26.

As shown in FIG. 7, the tripping member 75 is a simple flat member mounted to rotate on the same journal 29 as the pivoting bolt. The cam edge 76 defined above has a ramp-shaped end portion in the vicinity of on one side of the mouth of the slot 27 in the pivoting bolt.

The operation of the device that has just been described is obvious from the preceding description.

In the case of normal actuation by the panic bar associated with the mechanism shown in FIGS. 1 to 6, it is clear that, if said bar is pushed, the lever 22 is actuated and causes the actuator member 45 to pivot in the direction of the arrow F4, which causes the cam 35 to turn in the direction of the arrow F3, and consequently causes the profiled nose 38 of the pivoting bolt and the abutment 36 to separate. This situation is shown in FIG. 3 and is unstable, and the spring 30 immediately causes the pivoting bolt to swing to the position shown in FIG. 4.

From this moment, the pivoting bolt is in said escape position, and pushing on the door disengages the crossmember 14 from the keeper, which causes the door to open. It is clear that, even if a high force is applied to the door itself, this has little effect on the movement of the bolt. The force to be applied to open the door is therefore relatively insensitive to the force exerted on the door.

If an authorized person has a key for the cylinder that actuates the dog 68, the latter can be moved so that the plate carrying the tabs 58 comes into contact with the nut 60. This situation is shown in FIG. 5. From this moment, maneuvering the nut (FIG. 6) moves the tabs and consequently the cam 35. Because of this, the pivoting bolt can reach said escape position and the door can be opened from the outside without any action having been applied to the panic bar.

Finally, in the case of a double door, if the second door that carries the keeper 13 is opened first, the movement of the second door brings the crossmember into contact with the tripping member 75 on the side of the pivoting bolt and the tripping member operates directly on the roller constituting the abutment 36 of the cam 35. The cam turns in the direction shown in FIG. 3 and releases the pivoting bolt, allowing it to reach the position shown in FIG. 6. Consequently, the pivoting bolt no longer opposes opening of the second door and subsequent opening of the first door. When the door is closed following an emergency evacuation, the second door is closed first and locked by its top and bottom catches and the pivoting bolt of the mechanism 11 mounted on the first door is in the correct position to allow the first door to be closed, the pivoting bolt resuming the position shown in FIG. 1 when the cylindrical crossmember 14 of the keeper is again engaged in the slot 27.

1. A door maneuvering mechanism, in particular of the panic bolt type, characterized in that it includes, installed on a support adapted to be fixed to a door:
a pivoting bolt (26) with a slot adapted to receive a keeper external to said support,
a pivoting cam (35) with an abutment cooperating with a profiled nose of said bolt to prevent rotation thereof in a direction that would allow said bolt to reach an escape position in which said bolt and said keeper can separate, and
an actuator member (45) for actuating said cam, cooperating with an arm thereof to retract said abutment, and adapted to release said pivoting bolt to allow it to reach said escape position.

2. A mechanism according to claim 1, characterized in that said abutment (36) is a roller.

3. A mechanism according to claim 2, characterized in that said actuator member is pivoted and has a rounded end portion (50) adapted to cooperate with said arm.

4. A mechanism according to claim 2 or claim 3, characterized in that said roller is mounted between two parallel and similar members (46) of said cam and said two members are mounted on a common journal (42) and spaced by the length of said roller.

5. A mechanism according to the combination of claims 3 and 4, characterized in that said actuator member has two similar end portions (50) which are parallel and spaced by the same distance as that between said similar members (46), with which they respectively cooperate.

6. A mechanism according to any preceding claim, characterized in that it includes actuator means (55) for actuating said cam connected to a cylinder and/or a nut (60), cooperating with said cam to release said bolt and allow it to reach said escape position.

7. A mechanism according to claim 6, characterized in that said actuator means include a tab (58) cooperating with said cam and fastened to a mobile plate (59) adapted to be moved to a position of mechanical coupling with said cylinder and/or said nut.

8. A mechanism according to claim 7, characterized in that said plate is moved by a dog (68) commanding its coupling with a nut and said dog is moved by a cylinder.

9. A mechanism according to either claim 7 or claim 8, characterized in that said plate moves along guide rods (62) and is spring-loaded toward a position in which it cooperates with said cylinder and/or said nut.

10. A mechanism according to claim 9, characterized in that said dog (68) is a flat member sliding under said plate and incorporating a boss (70) with inclined edges, adapted, when it is in contact with said plate, to retain it in a position in which it is disengaged from said nut.

11. A mechanism according to any preceding claim, characterized in that one edge of said slot in said bolt is part of a weakened portion (76) thereof, adapted to be bent by an external force to a position where the force developed between the keeper and the bolt is substantially directed in the direction of the rotation axis of the latter.

12. A mechanism according to any preceding claim, characterized in that, to cooperate with a keeper (13) mounted on a second door, it further includes a tripping member (75) pivoting relative to said support and cooperating with said cam to actuate the latter in a direction tending to release said bolt, and said tripping member includes a cam edge (76) laterally juxtaposed to the slot in said bolt and shaped to cooperate with said keeper so that, on opening said second door, said keeper actuates said tripping member on being disengaged, which tripping member in turn moves said cam to release said bolt.

13. A mechanism according to claim 12, characterized in that said tripping member (75) is a flat member rotating on the same journal as said pivoting bolt.

14. A mechanism according to claim 12 or claim 13, characterized in that said cam edge (76) has a ramp-shaped end portion in the vicinity of the mouth of said slot.
